(19) United States
(12) Patent Application Publication
(10) Pub. No.: US 2026/0104391 A1
(43) Pub. Date: Apr. 16, 2026

(54) INSPECTION APPARATUS USING ULTRASONIC WAVES AND METHOD OF INSPECTING POWER MODULE USING ULTRASONIC WAVES

(71) Applicants: HYUNDAI MOTOR COMPANY, Seoul (KR); KIA CORPORATION, Seoul (KR)

(72) Inventor: Jae Hwan Lee, Hwaseong-si (KR)

(73) Assignees: HYUNDAI MOTOR COMPANY, Seoul (KR); KIA CORPORATION, Seoul (KR)

(21) Appl. No.: 19/045,392

(22) Filed: Feb. 4, 2025

(30) Foreign Application Priority Data
Oct. 11, 2024 (KR) 10-2024-0138218

(51) Int. Cl. G01N 29/06; G01N 29/265; G01N 29/44

(52) U.S. Cl. CPC G01N 29/0654; G01N 29/265; G01N 29/4454; G01N 2291/011; G01N 2291/103

(57) ABSTRACT

An inspection apparatus using ultrasonic waves is provided. The inspection apparatus includes a first ultrasonic wave scanner disposed at one side of an inspection target, the first ultrasonic wave scanner configured to move to scan the inspection target, and a second ultrasonic wave scanner disposed at the other side of the inspection target. The second ultrasonic wave scanner is configured to move to scan the inspection target. The first ultrasonic wave scanner is configured to transmit ultrasonic waves to the inspection target, and to receive first reflected ultrasonic waves, reflected from the inspection target. The second ultrasonic wave scanner is configured to receive penetration ultrasonic waves penetrated through the inspection target.

### CROSS-REFERENCE TO RELATED APPLICATION(S)

This application claims the benefit of priority to Korean Patent Application No. 10-2024-0138218 filed on Oct. 11, 2024, in the Korean Intellectual Property Office, the disclosure of which is incorporated herein by reference in its entirety.

### TECHNICAL FIELD

The present disclosure relates to an inspection apparatus using ultrasonic waves and a method of inspecting a power module using ultrasonic waves.

### BACKGROUND

Non-destructive testing (NDT) for obtaining an ultrasonic wave image of an inspection target using a signal having a frequency in an ultrasonic wave region has been used in various fields. The ultrasonic wave image may include at least one of an A-scan image, a B-scan image, and a C-scan image.

### SUMMARY

Aspects of the present disclosure provide an inspection apparatus using ultrasonic waves and a method of inspecting a power module using ultrasonic waves may (e.g., efficiently) obtain reflective ultrasonic wave data used to inspect characteristics (for example, bonding surface void defects, substrate void defects, substrate crack defects, and the like) of an inspection target (for example, a power module), and penetration ultrasonic wave data used to inspect other characteristics (for example, delamination defects, wire peripheral defects, and the like) of the inspection target (for example, a power module) together, and may (e.g., efficiently) inspect (e.g., various) characteristics (for example, bonding surface void defects, substrate void defects, substrate crack defects, delamination defects, wire peripheral defects, and the like) of the inspection target (for example, a power module).

According to the present disclosure, there is provided an inspection apparatus using ultrasonic waves. The inspection apparatus includes a first ultrasonic wave scanner disposed at one side of an inspection target, the first ultrasonic wave scanner configured to move to scan the inspection target, and a second ultrasonic wave scanner disposed at the other side of the inspection target, the second ultrasonic wave scanner configured to move to scan the inspection target. The first ultrasonic wave scanner may be configured to transmit ultrasonic waves to the inspection target, and to receive first reflected ultrasonic waves, reflected from the inspection target. The second ultrasonic wave scanner may be configured to receive penetration ultrasonic waves penetrated through the inspection target.

For example, the second ultrasonic wave scanner may be configured to transmit ultrasonic waves to the inspection target, and to receive second reflected ultrasonic waves, reflected from the inspection target.

For example, the inspection apparatus may further include a processor configured to generate a first C-scan image, based on the first reflected ultrasonic waves, to generate a second C-scan image, based on the second reflected ultrasonic waves, and to generate a T-scan image, based on the penetration ultrasonic waves.

For example, the first ultrasonic wave scanner may be configured to transmit first C-scan ultrasonic waves and T-scan ultrasonic waves to the inspection target. The second ultrasonic wave scanner may be configured to transmit second C-scan ultrasonic waves to the inspection target. The second ultrasonic wave scanner or the processor may be configured to distinguish the second reflected ultrasonic waves and the penetration ultrasonic waves from each other, based on a frequency difference or a time-of-flight difference.

For example, the inspection target may include a power module. The power module may include a first substrate disposed to oppose the first ultrasonic wave scanner, a second substrate disposed to oppose the second ultrasonic wave scanner, and a semiconductor device disposed between the first substrate and the second substrate. The processor may be configured to generate the first C-scan image including an image of the first substrate, the second C-scan image may include an image of the second substrate, and the T-scan image may include an image of the semiconductor device.

For example, the inspection apparatus may further include a processor configured to generate a first C-scan image, based on the first reflected ultrasonic waves, and to generate a T-scan image, based on the penetration ultrasonic waves. The first ultrasonic wave scanner may be configured to transmit first C-scan ultrasonic waves and T-scan ultrasonic waves to the inspection target.

For example, the inspection target may include a power module. The power module may include a first substrate and a semiconductor device disposed on the first substrate.

For example, the inspection apparatus may further include a mover configured to move the first ultrasonic wave scanner and the second ultrasonic wave scanner in a horizontal direction to scan the inspection target. The first ultrasonic wave scanner and the second ultrasonic wave scanner may be disposed to overlap each other in a vertical direction with the inspection target interposed therebetween.

For example, the first ultrasonic wave scanner may be moved by the mover for one cycle, and may be configured to transmit first C-scan ultrasonic waves and T-scan ultrasonic waves together to the inspection target whenever the inspection target is scanned (e.g., once).

For example, the inspection apparatus may further include a jig disposed between the first ultrasonic wave scanner and the second ultrasonic wave scanner to position (e.g., fix) the inspection target, and at least a portion of the mover has a U-shaped shape, which may surround the jig.

According to the present disclosure, there is provided a method of inspecting a power module using ultrasonic waves. The method may include disposing a power module, including a first substrate and a semiconductor device disposed on the first substrate, between a first ultrasonic wave scanner and a second ultrasonic wave scanner, and generating a first C-scan image, based on first reflected ultrasonic waves transmitted and received through the first ultrasonic wave scanner, and generating a T-scan image, based on penetration ultrasonic waves transmitted through the first ultrasonic wave scanner and received through the second ultrasonic wave scanner.

For example, generating the scan image includes generating a second C-scan image, based on second reflected ultrasonic waves transmitted and received through the second ultrasonic wave scanner.

For example, generating the scan image may further include transmitting first C-scan ultrasonic waves and T-scan ultrasonic waves through the first ultrasonic wave scanner, transmitting second C-scan ultrasonic waves through the second ultrasonic wave scanner, and distinguishing the second reflected ultrasonic waves and the penetration ultrasonic waves (e.g., from each other), based on a frequency difference or a time-of-flight difference.

For example, the power module may further include a second substrate disposed to oppose the second ultrasonic wave scanner. The first substrate may be disposed to oppose the first ultrasonic wave scanner. The semiconductor device may be disposed between the first substrate and the second substrate. Generating the scan image may include generating the first C-scan image including an image of the first substrate, the second C-scan image including an image of the second substrate, and the T-scan image including an image of the semiconductor device.

For example, generating the scan image may further include moving the first ultrasonic wave scanner and the second ultrasonic wave scanner in a horizontal direction to scan the power module. The first ultrasonic wave scanner and the second ultrasonic wave scanner may be disposed to overlap each other in a vertical direction with the power module interposed therebetween.

### BRIEF DESCRIPTION OF DRAWINGS

The aspects and features of the present disclosure will be understood from the detailed description and drawings, in which:

FIG. 1 is a perspective view of an inspection apparatus using ultrasonic waves according to an example embodiment of the present disclosure;

FIG. 2 is a side view of a power module inspected by an inspection apparatus using ultrasonic waves and a method of inspecting a power module using ultrasonic waves according to an example embodiment of the present disclosure;

FIG. 3 is a view of generating a C-scan image by an inspection apparatus using ultrasonic waves and a method of inspecting a power module using ultrasonic waves according to an example embodiment of the present disclosure;

FIG. 4 is a block diagram of ultrasonic wave scanners of an inspection apparatus using ultrasonic waves and a method of inspecting a power module using ultrasonic waves according to an example embodiment of the present disclosure; and

FIG. 5 is a flowchart of a method of inspecting a power module using ultrasonic waves according to an example embodiment of the present disclosure.

### DETAILED DESCRIPTION

Modifications may be made to the example embodiments. Here, the example embodiments are not construed as being limited to the disclosure and should be understood to include changes, equivalents, and replacements in accordance with this disclosure.

Terms such as first, second, A, B, (a), (b), and the like may be used herein to describe components. Each of these terminologies may distinguish the corresponding component from other component(s). For example, a first component may be referred to a second component, and similarly the second component may also be referred to as the first component. The term “and/or” may include combinations of a plurality of related described items or any of a plurality of related described items.

The terminology used herein describes example embodiments and may not limit the example embodiments. As used herein, the singular forms “a,” “an,” and “the” may include the plural forms, unless the context indicates otherwise. As used herein, the term “and/or” includes any one and any combination of any two or more of the associated listed items. The terms “comprises” and/or “comprising,” when used herein (e.g., in this code), may provide stated features, integers, steps, operations, elements, components or a combination thereof, but do not preclude one or more other features, integers, steps, operations, elements, components, and/or groups thereof.

The terms used herein including technical or scientific terms may be generally understood

As used herein, a vehicle (including an electric vehicle) refers to vehicles transporting a transported object such as a person, animal, or object from a starting point to a destination. Such vehicles are not limited to vehicles travelling on roads or tracks.

Herein, example embodiments of the present disclosure will be described with reference to the accompanying drawings.

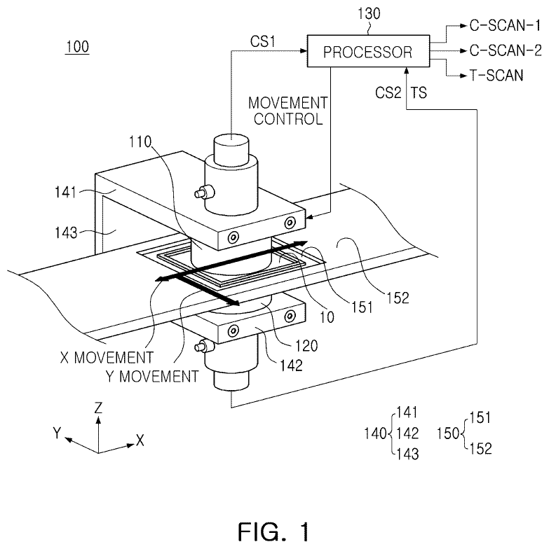

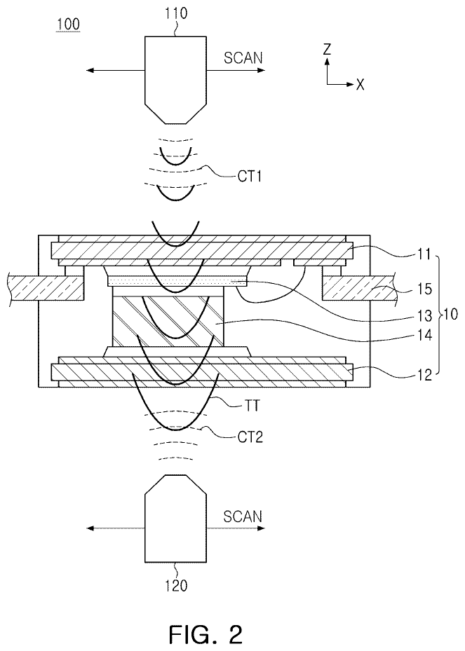

FIG. 1 is a perspective view of an inspection apparatus using ultrasonic waves according to an example embodiment of the present disclosure. FIG. 2 is a side view of a power module inspected by an inspection apparatus using ultrasonic waves and a method of inspecting a power module using ultrasonic waves according to an example embodiment of the present disclosure.

Referring to FIGS. 1 and 2, an inspection apparatus using ultrasonic waves 100 according to an example embodiment of the present disclosure may include a first ultrasonic wave scanner 110 disposed at one side (for example, a +Z-direction) of an inspection target 10 to scan the inspection target 10, and a second ultrasonic wave scanner 120 disposed at the other side (for example, −Z-direction) of the inspection target 10 to scan the inspection target 10. The first ultrasonic wave scanner 110 may transmit ultrasonic waves (for example, first C-scan ultrasonic waves CT1 and/or T-scan ultrasonic waves TT) to the inspection target 10, and may receive first reflected ultrasonic waves (e.g., corresponding to first reflected ultrasonic wave data CS1) reflected from the inspection target 10, and the second ultrasonic wave scanner 120 may receive penetration ultrasonic waves (e.g., corresponding to penetration ultrasonic wave data TS) penetrated through the inspection target 10.

The first reflected ultrasonic wave data CS1 may be used to inspect (e.g., some) characteristics (for example, bonding surface void defects, substrate void defects, substrate crack defects, and the like) of the inspection target 10, and the penetration ultrasonic wave data TS may be used to inspect (e.g., some) other characteristics (for example, delamination defects, wire peripheral defects, and the like) of the inspection target 10. The inspection apparatus using ultrasonic waves 100 according to an example embodiment of the present disclosure may obtain the first reflected ultrasonic wave data CS1 and the penetration ultrasonic wave data TS together even when one first ultrasonic wave scanner 110 is used, and thus may (e.g., efficiently) inspect (e.g., various) characteristics (for example, bonding surface void defects, substrate void defects, substrate crack defects, delamination defects, wire peripheral defects, and the like) of the inspection target 10.

The second ultrasonic wave scanner 120 may transmit ultrasonic waves (for example, second C-scan ultrasonic waves CT2) to the inspection target 10, and may receive second reflected ultrasonic waves (e.g., corresponding to second reflected ultrasonic wave data CS2) reflected from the inspection target 10. The first reflected ultrasonic wave data CS1 may be used to inspect upper characteristics (for example, bonding surface void defects, substrate void defects, substrate crack defects, and the like) of the inspection target 10, and the second reflected ultrasonic wave data CS2 may be used to inspect lower characteristics (for example, bonding surface void defects, substrate crack defects, and the like) of the inspection target 10, and the penetration ultrasonic wave data TS may be used to inspect central characteristics (for example, delamination defects, wire peripheral defects, and the like) of the inspection target 10.

Even when the two first and second ultrasonic wave scanners 110 and 120 are used, the inspection apparatus using ultrasonic waves 100 according to an example embodiment of the present disclosure may obtain the first reflected ultrasonic wave data CS1, second reflected ultrasonic wave data CS2, and penetration ultrasonic wave data TS together, thereby (e.g., efficiently) inspecting (e.g., various) characteristics (for example, bonding surface void defects, substrate void defects, substrate crack defects, delamination defects, wire peripheral defects, and the like) of (e.g., various) portions (for example, an upper portion, an intermediate portion, and a lower portion).

The first ultrasonic wave scanner 110 may transmit the first C-scan ultrasonic waves CT1 and the T-scan ultrasonic waves TT to the inspection target 10, and the second ultrasonic wave scanner 120 may transmit the second C-scan ultrasonic waves CT2 to the inspection target 10. For example, the first ultrasonic wave scanner 110 may adjust a frequency and/or an amplitude of ultrasonic waves to be transmitted, thereby (e.g., differently) implementing characteristics (for example, characteristics favorable for reflection) of the first C-scan ultrasonic waves CT1 and characteristics (for example, characteristics favorable for penetration) of the T-scan ultrasonic waves TT.

A processor 130 that may be included in the inspection apparatus using ultrasonic waves 100 may be configured to generate a first C-scan image C-SCAN-1, based on the first reflected ultrasonic waves (e.g., corresponding to the first reflected ultrasonic wave data CS1), to generate a second C-scan image C-SCAN-2, based on the second reflected ultrasonic waves (e.g., corresponding to the second reflected ultrasonic wave data CS2), and to generate a T-scan image T-SCAN, based on the penetration ultrasonic waves (e.g., corresponding to the penetration ultrasonic wave data TS). For example, the processor 130 may be implemented as a computing system (e.g., including a processor, memory, an input/output device, and a communication device), and may be implemented as a controller.

The first C-scan image C-SCAN-1 and the second C-scan image C-SCAN-2 may be two-dimensional images of a plurality of target layers positioned at different depths (or levels) of the inspection target 10. The T-scan image T-SCAN may be a two-dimensional (or three-dimensional) penetration image for internal volume analysis of the inspection target 10.

The mover 140 that may be included in the inspection apparatus using ultrasonic waves 100 may move the first ultrasonic wave scanner 110 and the second ultrasonic wave scanner 120 in a horizontal direction (for example, an X-direction and/or a Y-direction) to scan the inspection target 10. Accordingly, each of the first reflected ultrasonic wave data CS1, the second reflected ultrasonic wave data CS2, and the penetration ultrasonic wave data TS, obtained by the first and second ultrasonic wave scanners 110 and 120, may be implemented as two-dimensional data (ultrasonic wave data corresponding to a two-dimensional coordinate value). Depending on a design thereof, the penetration ultrasonic wave data TS may be implemented as three-dimensional data. The first ultrasonic wave scanner 110 and the second ultrasonic wave scanner 120 may be disposed to overlap (e.g., each other) in a vertical direction (for example, a Z-direction) with the inspection target 10 interposed therebetween.

For example, the first and second ultrasonic wave scanners 110 and 120 may perform scanning while moving in an X-direction for each of a plurality of Y-direction coordinates of the inspection target 10 or perform scanning while moving along a zigzag path, thereby transmitting and receiving ultrasonic waves with respect to (e.g., all of) a plurality of X-direction coordinates and the plurality of Y-direction coordinates of the inspection target 10. A one-cycle movement path of the mover 140 may be defined as a path, overlapping (e.g., each of) the plurality of X-direction coordinates and the plurality of Y-direction coordinates of the inspection target 10, in the Z-direction (e.g., once), and scanning the inspection target 10 (e.g., once) with respect to each of the plurality of X-direction coordinates and the plurality of Y-direction coordinates may be defined as scanning the inspection target 10 (e.g., once).

For example, the first ultrasonic wave scanner 110 may be moved by the mover 140 for one cycle, and may transmit, to the inspection target 10, the first C-scan ultrasonic waves CT1 and the T-scan ultrasonic waves TT together whenever the inspection target 10 is scanned (e.g., once). Accordingly, the inspection apparatus using ultrasonic waves 100 according to an example embodiment of the present disclosure may reduce time (e.g., required) to obtain the first reflected ultrasonic wave data CS1 and the penetration ultrasonic wave data TS together, thereby reducing total inspection time for (e.g., various) characteristics (for example, bonding surface void defects, substrate void defects, substrate crack defects, delamination defects, wire peripheral defects, and the like) of the inspection target 10. In an example embodiment, the second ultrasonic wave scanner 120 may also be moved by the mover 140 for one cycle, and may transmit the second C-scan ultrasonic waves CT2 to the inspection target 10 when (e.g., whenever) the inspection target 10 is scanned (e.g., once).

For example, the processor 130 may control movement of the mover 140. For example, the mover 140 may include an actuator (not illustrated) forming force for moving the first and second ultrasonic wave scanners 110 and 120 in the horizontal direction, and the processor 130 may transmit a signal for controlling force, formed by the actuator, to the mover 140. In an example embodiment, the processor 130 may provide (e.g., allow) target coordinates of the mover 140 to correspond to ultrasonic wave data.

For example, the mover 140 may include a first support portion 141 supporting the first ultrasonic wave scanner 110, a second support portion 142 supporting the second ultrasonic wave scanner 120, and a connection portion 143 connecting one ends of the first and second support portions 141 and 142 to each other. The first support portion 141 may have a through-hole through which the first ultrasonic wave scanner 110 passes, and the second support portion 142 may include a through-hole through which the second ultrasonic wave scanner 120 passes. The connection portion 143 may receive force formed by the actuator to move the first and second support portions 141 and 142, thereby moving the first and second ultrasonic wave scanners 110 and 120.

The jig 150 that may be included in the inspection apparatus using ultrasonic waves 100 may be disposed between the first ultrasonic wave scanner 110 and the second ultrasonic wave scanner 120 to position (e.g., fix) the inspection target 10. At least a portion of the mover 140 may have a U-shape, surrounding the jig 150. The first support portion 141, the connection portion 143, and the second support portion 142 may have a U-shape. The jig 150 may include a fixing portion 151 positioning (e.g., fixing) the inspection target 10, and a plate 152 providing a surface on which the fixing portion 151 is disposed. The plate 152 may have an (e.g., efficient) shape to be coupled to the U-shape of the mover 140.

Accordingly, a space, occupied by the mover 140 and the jig 150, may be (e.g., efficiently) compressed and stably accommodated in a specific structure (for example, a water tank). For example, a combination of the mover 140 and the jig 150 may be disposed in a water tank containing water, and thus may be in water. Water may be used as an ultrasonic wave transmission medium, and the water tank may include a device for receiving or circulating the water.

Referring to FIG. 2, the inspection target 10 may include a power module, and the power module may include at least one of a first substrate 11, a second substrate 12, a semiconductor device 13, a spacer 14, and a lead terminal 15. For example, the power module of the inspection target 10 may be (e.g., electrically) connected to a space between a motor for driving of an eco-friendly vehicle, such as an electric vehicle, and a battery, and may be implemented as an inverter converting a DC voltage of the battery into an AC voltage.

The first substrate 11 may be disposed to oppose the first ultrasonic wave scanner 110, and the second substrate 12 may be disposed to oppose the second ultrasonic wave scanner 120. The first substrate 11 and the second substrate 12, disposed to oppose the first ultrasonic wave scanner 110 and the second ultrasonic wave scanner 120, may include at least one surface (for example, upper surfaces or lower surfaces) of the first and second substrates 11 and 12 overlapping the first and second ultrasonic wave scanners 110 and 120 in a normal direction (for example, a Z-direction). For example, (e.g., each of) the first and second substrates 11 and 12 may be implemented as an active metal braided (AMB) substrate or a direct bonded copper (DBC) substrate, and may have a structure in which at least one metal layer (for example, a copper layer) and at least one insulating layer (for example, a ceramic layer) are alternately stacked.

The semiconductor device 13 may be disposed between the first substrate 11 and the second substrate 12. For example, the semiconductor device 13 may be implemented as an integrated circuit or a chip, and may be mounted on the first substrate 11 or the second substrate 12 through soldering or sintering. For example, the semiconductor device 13 may include one or more power semiconductor devices having a high-power capacity, such as an insulated gate bipolar transistor (IGBT) or a thyristor, or may include a silicon carbide (SiC)-based semiconductor device or a gallium nitride (GaN)-based semiconductor device.

The spacer 14 may be disposed to overlap the semiconductor device 13 in a direction (for example, a Z-direction) in which the first substrate 11 and the second substrate 12 oppose each other. When the semiconductor device 13 is mounted on the first substrate 11, the spacer 14 may be disposed between the semiconductor device 13 and the second substrate 12. For example, the spacer 14 may contain a metal (for example, copper (Cu) or molybdenum (Mo)) material, and may provide a heat dissipation path for the semiconductor device 13. For example, the spacer 14 may be adhered to each of the semiconductor device 13 and the second substrate 12 through a plurality of adhesive layers.

The lead terminal 15 may be (e.g., electrically) connected to the semiconductor device 13, and may extend in the horizontal direction (for example, an X-direction and/or a Y-direction). For example, the lead terminal 15 may (e.g., electrically) connect the power module of the inspection target 10 to an external motor or battery, and may provide a path for transmitting a control signal of a motor controller of a motor system to the semiconductor device 13.

The processor 130 may generate a first C-scan image C-SCAN-1 including an image of the first substrate 11, a second C-scan image C-SCAN-2 including an image of the second substrate 12, and a T-SCAN image T-SCAN including an image of the semiconductor device 13. For example, the first C-scan image C-SCAN-1 may be used to inspect defects (for example, internal void defects and bonding surface void defects) of the first substrate 11, and the second C-scan image C-SCAN-2 may be used to inspect defects (for example, internal voids and bonding surfaces) of the second substrate 12. The T-SCAN image T-SCAN may be used to inspect defects (for example, defects around wires) of the semiconductor device 13, and may be used to inspect defects that are challenging (e.g., difficult) to detect using a C-scan.

A space between the first and second substrates 11 and 12 of the power module may be obscured from viewpoints of the first and second ultrasonic wave scanners 110 and 120, and thus may be a space that is challenging (e.g., difficult) to inspect (or a space that is challenging (e.g., difficult) to secure inspection accuracy) (e.g., only) using the first C-scan image C-SCAN-1 and the second C-scan image C-SCAN-2. The T-scan image T-SCAN may be used to improve inspection accuracy for the space that is challenging (e.g., difficult) to inspect. The inspection apparatus using ultrasonic waves 100 and the method of inspecting a power module using ultrasonic waves according to an example embodiment of the present disclosure may further obtain a T-scan image T-SCAN without adding an ultrasonic wave scanner, thereby (e.g., efficiently) inspecting (e.g., various) defects (including defects that are challenging (e.g., difficult) to detect using a C-scan) of (e.g., various) portions of the power module (including the space that is challenging (e.g., difficult) to inspect).

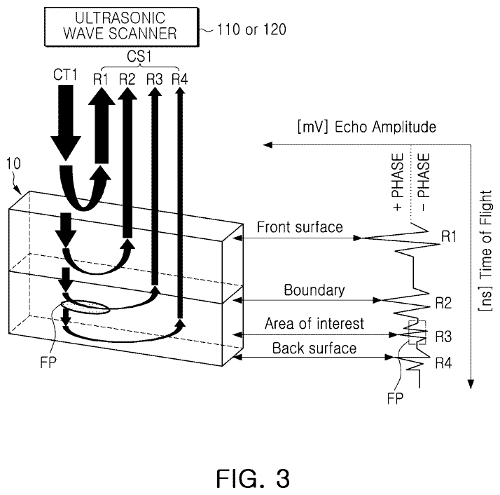

FIG. 3 is a view of generating a C-scan image by an inspection apparatus using ultrasonic waves and a method of inspecting a power module using ultrasonic waves according to an example embodiment of the present disclosure.

Referring to FIG. 3, the first ultrasonic wave scanner 110 may transmit first C-scan ultrasonic waves CT1 to the inspection target 10, receive first reflected ultrasonic waves R1, R2, R3, and R4, and generate first reflected ultrasonic wave data CS1, based on the first reflected ultrasonic waves R1, R2, R3, and R4. Second C-scan ultrasonic waves and second reflected ultrasonic wave data of the second ultrasonic wave scanner 120 may be implemented similar to that of the first C-scan ultrasonic waves CT1 and the first reflected ultrasonic wave data CS1.

For example, a portion of the first C-scan ultrasonic waves CT1 may be reflected from a front surface (for example, an upper surface of the first substrate 11 (in FIG. 2)) of the inspection target 10. Thereafter, a portion of the first C-scan ultrasonic waves CT1 may be reflected from a boundary of the inspection target 10 (for example, a boundary between a metal layer and an insulating layer of the first substrate 11 (in FIG. 2)). Thereafter, a portion of the first C-scan ultrasonic waves CT1 may be reflected from a defect FP (for example, an internal void of the first substrate 11 (in FIG. 2)) of the inspection target 10. Thereafter, a portion of the first C-scan ultrasonic waves CT1 may be reflected from a back surface (for example, a lower surface of the first substrate 11 (in FIG. 2)) of the inspection target 10.

For example, the first ultrasonic wave scanner 110 may identify reflection positions (for example, a front surface, a boundary, an area of interface, and a back surface) of the first reflected ultrasonic waves R1, R2, R3, and R4, based on echo amplitudes and/or times of flight of the first reflected ultrasonic waves R1, R2, R3, and R4. This may be because the echo amplitudes and/or the times of flight of the first reflected ultrasonic waves R1, R2, R3, and R4 may be determined based on medium characteristics (for example, sound wave impedance and density) of the reflection positions of the first reflected ultrasonic waves R3, and R4. For example, the second ultrasonic wave scanner 120 or the processor 130 (in FIG. 1) may distinguish, based on a time-of-flight difference, second reflected ultrasonic waves and penetration ultrasonic waves from each other.

The first reflected ultrasonic wave data CS1 may include reception coordinate data of the first reflected ultrasonic waves R3, and may include time-of-flight data of the first reflected ultrasonic waves R3. The time-of-flight data may be Z-direction position information of the defect FP. The processor 130 (in FIG. 1) may generate a first C-scan image including an image of the inspection target 10 based on the first reflected ultrasonic waves R1, R2, and R4 of the first reflected ultrasonic wave data CS1, and an image of the defect FP based on the first reflected ultrasonic waves R3.

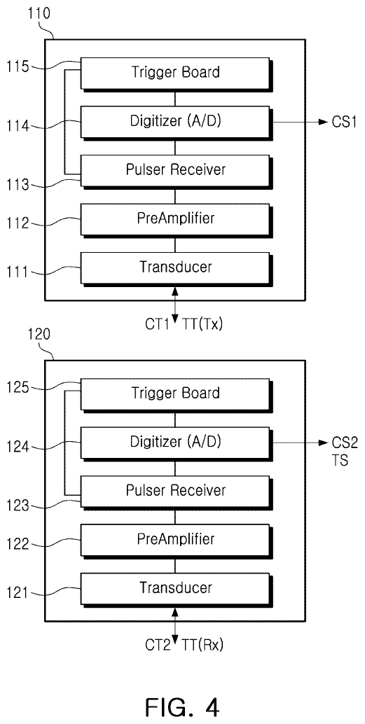

FIG. 4 is a block diagram of ultrasonic wave scanners of an inspection apparatus using ultrasonic waves and a method of inspecting a power module using ultrasonic waves according to an example embodiment of the present disclosure.

Referring to FIG. 4, the first and second ultrasonic wave scanners 110 and 120 may refer to signal processing system modules including transducers 111 and 121, respectively. For example, the first and second ultrasonic wave scanners 110 and 120 may include transducers 111 and 121, pre-amplifiers 112 and 122, pulsar receivers 113 and 123, A/D converters 114 and 124, and trigger boards 115 and 125, respectively.

The transducers 111 and 121 may be configured to convert an electrical signal and an ultrasonic signal. The pre-amplifiers 112 and 122 may be configured to amplify an electrical signal (or an ultrasonic signal). The pulsar receivers 113 and 123 may generate or process the electrical signal. For example, the pulsar receivers 113 and 123 may generate an electrical signal and transmit the electrical signal to the pre-amplifiers 112 and 122, the pre-amplifiers 112 and 122 may amplify the electrical signal, and the transducers 111 and 121 may convert the electrical signal into an ultrasonic signal and output the ultrasonic signal. For example, the transducers 111 and 121 may convert the received ultrasonic signal (for example, reflected ultrasonic waves or penetration ultrasonic waves) to the pre-amplifiers 112 and 122, the pre-amplifiers 112 and 122 may amplify the electrical signal, and the pulsar receivers 113 and 123 may receive and process the electrical signal.

For example, the transducers 111 and 121 and/or the pulsar receivers 113 and 123 may determine a frequency for each type of ultrasonic signal (for example, the first C-scan ultrasonic waves CT1, the second C-scan ultrasonic waves CT2, and the T-scan ultrasonic waves TT). Accordingly, the second ultrasonic wave scanner 120 or the processor 130 (in FIG. 1) may distinguish, based on a frequency difference, second reflected ultrasonic waves and penetration ultrasonic waves from each other.

The A/D converters 114 and 124 may convert electrical signals received by the pulsar receivers 113 and 123 from analog signals to digital signals (for example, first and second reflected ultrasonic wave data or penetration ultrasonic wave data), and may transmit the digital signals to the processor 130 (in FIG. 1).

The trigger boards 115 and 125 may store information on a timing at which the first and second ultrasonic wave scanners 110 and 120 are to transmit ultrasonic waves, and may control a point in time of generation of an electrical signal by triggering the pulsar receivers 113 and 123 according to the information on the timing. In an example embodiment, the trigger boards 115 and 125 may convert the trigger signal into a digital timing signal through the A/D converters 114 and 124 and transmit the digital timing signal to the processor 130 (in FIG. 1). The processor 130 (in FIG. 1) may be synchronized with the first and second ultrasonic wave scanners 110 and 120 through the digital timing signal.

Alternatively, the A/D converters 114 and 124 may receive a control signal from the processor 130 (in FIG. 1) and transmit the control signal to the trigger boards 115 and 125, and the trigger boards 115 and 125 may control a point in time of generation of an electrical signal of the pulsar receivers 113 and 123 according to the control signal.

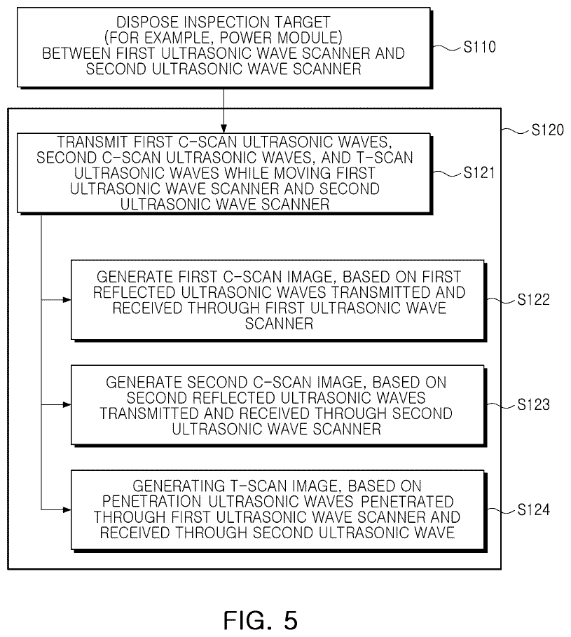

FIG. 5 is a flowchart of a method of inspecting a power module using ultrasonic waves according to an example embodiment of the present disclosure.

Referring to FIG. 5, a method of inspecting a power module using ultrasonic waves according to an example embodiment of the present disclosure may include an disposal operation S110 of disposing a power module (an example of an inspection target 10) including a first substrate 11 and a semiconductor device 13 disposed on the first substrate 11 between a first ultrasonic wave scanner 110 and a second ultrasonic wave scanner 120, and a scan image generation operation S120 of generating a first C-scan image C-SCAN-1, based on first reflected ultrasonic waves (e.g., corresponding to first reflected ultrasonic wave data CS1) transmitted and received through the first ultrasonic wave scanner 110 (S122), and generating a T-scan image, based on the penetration ultrasonic waves (e.g., corresponding to the penetration ultrasonic wave data TS) penetrated through the first ultrasonic wave scanner 110 and received through the second ultrasonic wave scanner 120 (S124).

The scan image generation operation S120 may further include moving the first ultrasonic wave scanner 110 and the second ultrasonic wave scanner 120 in a horizontal direction to scan the power module (an example of the inspection target 10), and transmitting first C-scan ultrasonic waves CT1 and T-scan ultrasonic waves TT through the first ultrasonic wave scanner 110 (S121). Transmitting S121 may further include transmitting second C-scan ultrasonic waves CT2 through the second ultrasonic wave scanner 120.

The scan image generation operation S120 may include generating a second C-scan image C-SCAN-2, based on second reflected ultrasonic waves (e.g., corresponding to second reflected ultrasonic wave data CS2) transmitted and received through the second ultrasonic wave scanner 120 (S123).

The scan image generation operation S120 may further include distinguishing the second reflected ultrasonic waves (e.g., corresponding to the second reflected ultrasonic wave data CS2) and penetration ultrasonic waves (e.g., corresponding to penetration ultrasonic wave data TS) from each other, based on a frequency difference or a time-of-flight difference.

The scan image generating operation S120 may include generating a first C-scan image C-SCAN-1 including an image of the first substrate 11, a second C-scan image C-SCAN-2 including an image of the second substrate 12, and a T-scan image T-SCAN including an image of the semiconductor device 13.

According to the present disclosure, an inspection apparatus using ultrasonic waves and a method of inspecting a power module using ultrasonic waves may (e.g., efficiently) obtain reflective ultrasonic wave data used to inspect (e.g., some) characteristics (for example, bonding surface void defects, substrate void defects, substrate crack defects, and the like) of an inspection target (for example, a power module), and penetration ultrasonic wave data used to inspect (e.g., other) characteristics (for example, delamination defects, wire peripheral defects, and the like) of the inspection target (for example, a power module) together, and may (e.g., efficiently) inspect (e.g., various) characteristics (for example, bonding surface void defects, substrate void defects, substrate crack defects, delamination defects, wire peripheral defects, and the like) of the inspection target (for example, a power module).

While example embodiments have been shown and described above, modifications and variations could be made without departing from the scope of the present disclosure as defined by the appended claims.

What is claimed is:

1. An inspection apparatus using ultrasonic waves, the inspection apparatus comprising:
a first ultrasonic wave scanner disposed at one side of an inspection target, the first ultrasonic wave scanner configured to move to scan the inspection target; and
a second ultrasonic wave scanner disposed at the other side of the inspection target, the second ultrasonic wave scanner configured to move to scan the inspection target,
wherein the first ultrasonic wave scanner is configured to transmit ultrasonic waves to the inspection target, and to receive first reflected ultrasonic waves, reflected from the inspection target, and
the second ultrasonic wave scanner is configured to receive penetration ultrasonic waves penetrated through the inspection target.

2. The inspection apparatus of claim 1, wherein the second ultrasonic wave scanner is configured to transmit ultrasonic waves to the inspection target, and to receive second reflected ultrasonic waves, reflected from the inspection target.

3. The inspection apparatus of claim 2, further comprising:
a processor configured to generate a first C-scan image, based on the first reflected ultrasonic waves, to generate a second C-scan image, based on the second reflected ultrasonic waves, and to generate a T-scan image, based on the penetration ultrasonic waves.

4. The inspection apparatus of claim 3, wherein
the first ultrasonic wave scanner is configured to transmit first C-scan ultrasonic waves and T-scan ultrasonic waves to the inspection target,
the second ultrasonic wave scanner is configured to transmit second C-scan ultrasonic waves to the inspection target, and
the second ultrasonic wave scanner or the processor is configured to distinguish the second reflected ultrasonic waves and the penetration ultrasonic waves, based on a frequency difference or a time-of-flight difference.

5. The inspection apparatus of claim 3, wherein
the inspection target includes a power module,
the power module includes:
a first substrate disposed to oppose the first ultrasonic wave scanner;
a second substrate disposed to oppose the second ultrasonic wave scanner; and
a semiconductor device disposed between the first substrate and the second substrate, and
the processor is configured to generate the first C-scan image including an image of the first substrate, the second C-scan image including an image of the second substrate, and the T-scan image including an image of the semiconductor device.

6. The inspection apparatus of claim 1, further comprising:
a processor configured to generate a first C-scan image, based on the first reflected ultrasonic waves, and to generate a T-scan image, based on the penetration ultrasonic waves, and
wherein the first ultrasonic wave scanner is configured to transmit first C-scan ultrasonic waves and T-scan ultrasonic waves to the inspection target.

7. The inspection apparatus of claim 6, wherein
the inspection target includes a power module, and
the power module includes a first substrate and a semiconductor device disposed on the first substrate.

8. The inspection apparatus of claim 1, further comprising:
a mover configured to move the first ultrasonic wave scanner and the second ultrasonic wave scanner in a horizontal direction to scan the inspection target,
wherein the first ultrasonic wave scanner and the second ultrasonic wave scanner are disposed to overlap in a vertical direction with the inspection target interposed therebetween.

9. The inspection apparatus of claim 8, wherein the first ultrasonic wave scanner is moved by the mover for one cycle and is configured to transmit first C-scan ultrasonic waves and T-scan ultrasonic waves together to the inspection target whenever the inspection target is scanned.

10. The inspection apparatus of claim 8, further comprising:
a jig disposed between the first ultrasonic wave scanner and the second ultrasonic wave scanner to position the inspection target, and
at least a portion of the mover has a U-shaped shape, surrounding the jig.

11. A method of inspecting a power module using ultrasonic waves, the method comprising:
disposing a power module, including a first substrate and a semiconductor device disposed on the first substrate, between a first ultrasonic wave scanner and a second ultrasonic wave scanner; and
generating a first C-scan image, based on first reflected ultrasonic waves transmitted and received through the first ultrasonic wave scanner, and generating a T-scan image, based on penetration ultrasonic waves transmitted through the first ultrasonic wave scanner and received through the second ultrasonic wave scanner.

12. The method of claim 11, wherein the generating the scan image includes generating a second C-scan image, based on second reflected ultrasonic waves transmitted and received through the second ultrasonic wave scanner.

13. The method of claim 12, wherein the generating the scan image further includes:
transmitting first C-scan ultrasonic waves and T-scan ultrasonic waves through the first ultrasonic wave scanner;
transmitting second C-scan ultrasonic waves through the second ultrasonic wave scanner; and
distinguishing the second reflected ultrasonic waves and the penetration ultrasonic waves, based on a frequency difference or a time-of-flight difference.

14. The method of claim 12, wherein
the power module further includes a second substrate disposed to oppose the second ultrasonic wave scanner,
the first substrate is disposed to oppose the first ultrasonic wave scanner,
the semiconductor device is disposed between the first substrate and the second substrate, and
the generating the scan image includes generating the first C-scan image including an image of the first substrate, the second C-scan image including an image of the second substrate, and the T-scan image including an image of the semiconductor device.

15. The method of claim 12, wherein
the generating the scan image further includes moving the first ultrasonic wave scanner and the second ultrasonic wave scanner in a horizontal direction to scan the power module, and
the first ultrasonic wave scanner and the second ultrasonic wave scanner are disposed to overlap in a vertical direction with the power module interposed therebetween.
